(19) United States
(12) Patent Application Publication
(10) Pub. No.: US 2011/0039217 A1
(43) Pub. Date: Feb. 17, 2011

(54) METHOD AND GAS REGULATOR FITTING FOR MONITORING THE IGNITION OF A GAS DEVICE

(75) Inventor: Barbara Happe, Gernrode (DE)

Correspondence Address: HOWARD & HOWARD ATTORNEYS PLLC, 450 West Fourth Street, Royal Oak, MI, 48067, US

(73) Assignee: MERTIK MAXITROL GMBH & CO., KG, THALE (DE)

(21) Appl. No.: 12/989,941

(22) PCT Filed: Apr. 27, 2009
(86) PCT No.: PCT/EP09/03037

§ 371 Date: Oct. 27, 2010

(30) Foreign Application Priority Data
Apr. 28, 2008 (DE) 10-2008-021164.8

(51) Int. Cl. F23N 1/00; F16K 31/02

(52) U.S. Cl. 431/12; 137/487.5

(57) ABSTRACT

A method and a gas regulator fitting for monitoring the ignition of a gas appliance in which the danger of the accumulation of an increased amount of unburned gas in a combustion chamber before the ignition of a main burner (2) is reduced. In addition, an immediate renewed attempt to ignite the appliance is to be prevented. A sensor (21) ascertaining the operating condition of the main burner (2) is activated in such a way on the activation of a drive unit (20) forming part of the gas regulator fitting for opening a main valve (11) of the gas regulator fitting such that, if the main gas flow in the main burner (2) is not ignited within a given time, the main valve (11) is closed again also for a given time.

### TECHNICAL FIELD OF THE INVENTION

The invention relates to a method of monitoring the ignition of a gas appliance whose function is controlled by a gas regulator fitting, and a gas regulator fitting for carrying out this method.

### STATE OF THE ART

Gas regulator fittings for gas heaters or the like exist in a wide range of designs. They serve to ignite and control or regulate a gas flow flowing towards a burner.

A method of igniting a gas flow is therefore known from DE 103 05 929 B3 for example. In this method an electronic control unit fed by a voltage source controls a safety pilot magnet for keeping open a thermoelectric safety pilot valve that shuts off the gas flow. As soon as the safety pilot magnet has been stimulated, a solenoid is stimulated for a short period by a voltage impulse whereby an operating rod opens the safety pilot valve, applying the anchor of the safety pilot magnet in the process. The anchor is held by the holding current from the voltage source until a thermocouple provides the required holding current after the gas flow has been ignited or else a given holding time has been exceeded. Once the pilot light is burning, the main valve can be opened via the drive unit. The gas flows to the main burner and is ignited by the pilot light.

A disadvantage of this method is that no check is made that the main burner has ignited. It is known from practice that flow problems in the area of the main burner can lead to problems in igniting the main burner. This is particularly problematic with gas heaters installed in fireplaces where faux wood or similar used for decorative effect has been arranged incorrectly in the combustion chamber. This gives rise to a risk that the main burner will be ignited only after a very large amount of gas has accumulated, leading to the risk of an explosion.

In addition, a gas regulator fitting is described in DE 10 2004 012 202 A1 in which, after initial start up of the gas heater, the pilot light is also put into the off position when the main burner is put into the off position in order to minimise the energy consumption of the gas heater. For this purpose the gas regulator fitting has a sensor which enables the operating condition of the main burner to be ascertained. In this arrangement the sensor is connected to the thermoelectric safety pilot valve in such a way that a signal sent from the sensor causes the thermoelectric safety pilot valve to assume its closed position when the operating condition of the main burner is changed from the “one” to the “off” position.

Here too there is no check that the main burner has ignited which leads to the discs advantages set out above.

### SUMMARY OF THE INVENTION

The aim of the invention is to devise a method for monitoring the ignition of a gas appliance whose function is controlled by a gas regulator fitting, and a gas regulator fitting for carrying out this method in which the danger of the accumulation of an increased amount of unburned gas in the combustion chamber before the ignition of the main burner is reduced. In addition, the aim is to prevent an immediate renewed ignition attempt. Moreover, the construction of the gas regulator fitting is to be as simple as possible.

This aim is achieved according to the invention in that in the method for monitoring the ignition of a main burner of a gas appliance whose function is controlled by a gas regulator fitting, a sensor ascertaining the operating condition of the main burner is activated in such a way on the activation of a drive unit forming part of the drive unit for opening the main valve of the gas regulator fitting that, if the main gas flow in the main burner is not ignited within a given time, the main valve is closed again also for a given time.

To that end the gas regulator fitting for monitoring the ignition of a main burner of a gas appliance for carrying out the method comprises an electronic control unit fed by a voltage source, a thermoelectric safety pilot valve for shutting off the gas flow with a safety pilot magnet, whose coil lies on the one hand in the circuit of a thermocouple heated by the gas flame and is on the one hand controllable via the electronic control unit, a drive unit which controls the amount of gas flowing to a main burner by means of a switch and a sensor connected to the main valve via to the electronic control unit, said sensor being so arranged that the operating condition of the main burner can be ascertained.

A solution has therefore been found that has overcome the above-mentioned disadvantages of the state of the art. At the same time, the solution is of simple construction with a simple mode of operation.

In an advantageous embodiment of the method both the main valve and the safety pilot valve are closed again for a given time if the main gas flow is not ignited in the main burner within a given time.

The associated extinguishing of the pilot light prevents a subsequent ignition of the gas that is already in the combustion chamber despite the fact that the main valve had already been closed. This arrangement increases safety still further.

### EXECUTION EXAMPLE

The method according to the invention for monitoring the ignition of a gas appliance, and a gas regulator fitting for carrying out this method is explained below in detail by means of an execution example. The execution example shows in a schematic diagram an embodiment of a gas regulator fitting in sectional view in the open position.

The gas regulator fitting according to the invention shown by way of example in the illustration is a switching and control device that is preferably intended for installation in a gas-fired heater installed in a fireplace or the like. It enables a burner to be operated and monitored by controlling the amount of gas flowing to the burner. In this execution example the burner comprises a pilot light 1 and a main burner 2.

The gas regulator fitting comprises a housing 3 that has a gas inlet 4, a pilot light outlet 5 and main gas outlet 6. The individual functional units are located in the housing 3.

A means of control is provided by an electronic control unit 7 which in this execution example is located together with a voltage source in a separate housing of a remote control unit 8 which can be positioned where required.

The following functional units are housed in the gas regulator fitting depicted:
Start-up unit 9 with safety pilot valve 10 and main valve 11
Control unit 12 for the amount of gas flowing to the main burner 2.

In addition, the interior of the housing 3 is divided into different chambers by a partition panel 13. An initial opening 14 in the partition panel 13 forms on the one hand together with a valve head 15 a main valve 11 and is on the other hand part of a safety pilot valve 10. The safety pilot valve 10 is controlled by a thermoelectric safety pilot magnet 16 located downstream of the gas inlet 4. The thermoelectric safety pilot magnet 16 can be stimulated by the electronic control unit 7, as well as by a thermocouple 17 exposed to the pilot light.

Within the housing 3 in the direction of flow downstream of the start-up unit 9 there is a switch 18 forming part of the control unit 12 constructed in the known manner in such a way as to effect a modulating control of the amount of gas flowing to the main gas outlet 6 by means of the additional openings 22/23 located in the partition wall 13, with stepwise switching on and off in the partial load region.

A longitudinally moving tappet 19 which is in non-positive connection with the switch 18 projects from the housing 3 and is connected to a drive unit 20 which is not described in further detail as experts will already be familiar with this type of device. The drive unit 20 is controlled by the remote control 8 via the electronic control unit 7.

A sensor 21 which is arranged in close proximity to the flames of the main burner 2 and which in this execution example is temperature-sensitive is connected to the electronic control unit 7.

The structure and mode of operation of the functional units will also be familiar to experts so that a detailed description of these units can be dispensed with.

The mode of operation of the gas regulator fitting is as follows:

After the gas appliance has been started up with the consequential ignition of the pilot light, the drive unit 20 for opening the switch 18 can be activated via the remote control 8 and the electronic control unit 7. In this process the openings 22 and 23 are released and the gas flows via the main gas outlet 6 to the main burner 2 to be ignited by the pilot light. When ignition has successfully taken place, the flames burn with their maximum height, the sensor 21 is heated and there is a feedback signal to the electronic control unit 7. The amount of gas flowing to the main burner 2 can be regulated by activating the drive unit 20. The switch 18 is from now on in the modulating area.

If the main burner 2 is not ignited within a given time, even though a largish amount of gas has already flowed into the combustion chamber, because no ignitable gas-air mixture has yet formed in the area of the pilot light owing to flow problems caused, for example, by an incorrect arrangement of faux wood in a heater installed in a fireplace, the safety pilot valve 10 and the main valve 11 are closed by the electronic control unit 7 for a given minimum time because of the absence of a feedback signal from the sensor 21, enabling the amount of gas accumulated in the combustion chamber to disperse/escape. After the minimum time set has elapsed, a renewed attempt can be made to start up the appliance.

### LIST OF REFERENCE NUMERALS

1 Pilot light
2 Main burner
3 Housing
4 Gas inlet
5 Pilot gas outlet
6 Main gas outlet
7 Electronic control unit
8 Remote control unit
9 Start-up unit
10 Safety pilot valve
11 Main valve
12 Control unit
13 Partition wall
14 Opening
15 Valve head
16 Safety pilot magnet
17 Thermocouple
18 Switch
19 Tappet
20 Drive unit
21 Sensor
22 Opening
23 Opening

1. A method for monitoring the ignition of a main burner (2) of a gas appliance controlled via a gas regulator fitting having a main valve (11) upstream of and in fluidic communication with a switch (18) for controlling the flow of gas to the main burner, a drive unit (20) operatively connected to the switch for controlling operation of the switch, and a control unit in communication with the main valve (11) and the drive unit (20) for controlling operation of the main valve (11) and the drive unit (20), said method comprising the steps of:
opening the main valve (11) and the switch (18) to deliver gas to the main burner (2);
ascertaining the operating condition of the main burner (2) with a sensor (21);
closing the main valve (11) for a first preset period of time in response to the main gas flow in the main burner (2) not being ignited within a second preset period of time.

2. A method for monitoring the ignition of a main burner of a gas appliance according to claim 1 wherein the gas regulator fitting further includes a safety pilot valve (10) in communication with the control unit (7) and disposed upstream from a pilot light (1) utilized to ignite the main burner (2), said method further comprising the step of closing the safety pilot valve (10) for a third preset period of time in response to the main burner (2) not being ignited within the first preset period of time.

3. Gas regulator fitting for monitoring the ignition of a main burner (2) of a gas appliance, comprising
an electronic control unit (7) fed by a voltage source,
a thermoelectric safety pilot valve (10) for shutting off the gas flow to the main burner (2) and a pilot light (1), said thermoelectric safety pilot valve (10) controllable by a thermocouple (17) heated by the gas flame of the pilot light (1) and the electronic control unit (7),
a main valve (10) downstream of said thermoelectric safety pilot valve (10) for shutting off the gas flow to the main burner (2),
a drive unit (20) which controls the amount of gas flowing to a main burner (2) by means of a switch (18), and
a sensor (21) connected to the main valve (11) via the electronic control unit (7), said sensor being so arranged that the operating condition of the main burner (2) can be ascertained, and wherein
said electronic control unit (7) closes the main valve (11) for a first preset period of time in response to the main gas flow in the main burner (2) not being ignited within a second preset period of time.
